(19) United States
(12) Patent Application Publication
(10) Pub. No.: US 2008/0244408 A1
(43) Pub. Date: Oct. 2, 2008

(54) Internet Search Engine with Display

(76) Inventors: Jimmy Dugan King, Kiowa, CO (US); Nicholas Duarte, Castle Rock, CO (US)

Correspondence Address: KYLE W. ROST, 5490 S. AUTUMN CT., GREENWOOD VILLAGE, CO, 80111, US

(21) Appl. No.: 11/694,828

(22) Filed: Mar. 30, 2007

(51) Int. Cl. G06F 3/048; G06F 3/00; G06F 17/30

(52) U.S. Cl. 715/719; 715/781

(57) ABSTRACT

The display of a search engine provides advertisements with video and audio content. A plurality of search results is displayed on a web page with a paired video advertisement. The advertisements are ordered and the audio portion of each advertisement is played according to the ordering. Each search result is listed by web site with a plurality of web pages from each web site shown as thumbnail images. One of the images is a hit page from the website and is highlighted. Additional hit pages are indicated in another field. If the website has more pages than the number of image fields, all pages of the website are streamed through the image fields. The advertisement paired with a website in the search results may be selected based on the search term or any derivation of the search, including tags on the website or hit page.

### BACKGROUND OF THE INVENTION

1. Field of the Invention

The invention generally relates to data processing and to database and file management or data structures. More specifically, the invention relates to database or file accessing and to access augmentation or optimizing.

2. Description of Related Art Including Information Disclosed Under 37 CFR 1.97 and 1.98

The invention provides retrieval and presentation of data from a network. One of the chief uses of the invention is to present data available on a computer network. For example, the invention presents data carried over the Internet, such as on the collection of resources known as the World Wide Web (www), which runs on the Internet. The structure and function of the Internet and World Wide Web provide general background to the purpose of the invention. Some key concepts related to the Internet and World Wide Web are described below. These descriptions are illustrative of limited aspects of the Internet and World Wide Web and are not exhaustive. Reference to the Internet also is representative of still other computer networks, mutatis mutandis. Reference to the World Wide Web also is representative to other resources on a network. The Internet and the World Wide Web are described for purpose of example and not limitation.

The Internet can be generally defined as a computer network that interconnects countless smaller computer networks and individual computers. The Internet carries a wide variety of informational content that is publically accessible, by use of standard protocols, to users having access to the Internet network. The World Wide Web is a collection of interrelated resources that runs on the Internet.

One of the most common types of resource within the World Wide Web is the website or host site. A website is a document or discrete collection of information that is identified by a specific resource locator, which also identifies the location of the website within the network, typically at a specified server or virtual server. Thus, in many instances a website is a hosted location on the network and presents data in a plurality of subgroups, referred to as web pages.

A website can be accessed by a web browser, which is a software application that locates a specified website and presents the content to the user. The resource locator for a website in the World Wide Web is referred to as a URL or uniform resource locator. A resource locator may employ a domain name, virtual domain name, or hostname in addition to other necessary information for locating a resource. The hostname or domain name frequently is a commonly understandable word, business name, or descriptive term. The Internet employs a naming system referred to as a domain name system (DNS) of domain name servers that translate a human-friendly domain name or hostname into a computer-friendly numerical address for the website or resource. The numerical address is referred to as the IP address or Internet Protocol address.

A website often is known to human users of the Internet network by its URL or hostname. The human-friendly URL names are highly useful for the additional reason that the IP address can be changed while the URL name remains the same. Thus, a website in a particular domain can be moved to a new location, such as to a different server on the Internet, without requiring a change in the URL or hostname. The URL or hostname merely is updated to the new IP address on the DNS servers.

A website on the World Wide Web may be a collection of web pages. The URL or hostname that is catalogued on DNS servers identifies the website in general and is linked to an IP address of the website. In general, reference to a hostname will refer to a general name for a website, registered with DNS servers. A web page within a website may be given its own human-friendly URL, which typically is the URL or hostname with added identifiers. A web page address within a website typically will not be catalogued at a top level domain name server. Rather, the DNS server will provide the location of the domain of the website. A lower level directory, perhaps associated with the website itself, may translate the added identifiers to the various web pages within a website. Of course, an individual web page can be equivalent to a website and have its own hostname.

Often the information on a collection of pages within a website is interrelated in some manner. The web pages may be hyperlinked together so that they may be viewed in an order. A hyperlink is a navigation aid that directs a web browser to an IP address. Although each web page has its own IP address, users often access a website by the URL of the domain to first reach the opening web page, referred to as the homepage, and then navigate through the website using the hyperlinked ordering of the pages.

A web browser can locate and present a web page by its URL or IP address. In addition, a web browser can follow hyperlinks that may be present on a presented web page to locate and present the targeted web pages. These methods of reaching web pages are limited in their adequacy. The user may not know any URL for a web page containing the information he desires. Even if the user knows one or more web pages containing desired information, the system of hyperlinks on the known web pages may be incomplete and may fail to lead to other relevant web pages.

Web search engines have been developed to overcome these limitations and to facilitate the location of relevant web pages. A web search engine operates by referring to a database or archive of selected, recorded information about resources on a network. A search engine typically operates by keyword searching. The search engine consults the indexed database and determines which resources, such as which web pages, refer to the search keyword. Then, by various proprietary schemes, the search engine returns an ordered listing of the resources that were located.

As presently practiced by web search engines, each individual listing of a web page presents a fragment of text containing the keyword as found on a web page. The user is able to review the list and select any web page, based upon the fragment of text. The listing includes a hyperlink to the web page, allowing the web browser to locate and present the selected web page.

The search engine employs an automated software application known as a spider or web crawler to survey the available web pages of the World Wide Web or other body of information. The web crawler is similar to a browser, in that it presents the content or a selected portion of the content for indexing in the database. When a user initiates a keyword search, the search engine refers to the database in order to identify content and location. The returned listing includes the hyperlink to the web page, itself, rather than to the database. Often, the search engine will include a separate hyperlink to the version of the web page in the database.

A website frequently includes characterizing terminology in a header that is invisible to the viewer but discoverable by search engines and web crawlers. Such terminology is known as tags, sometimes called meta tags or keyword tags. Tags help the search engine select the website as relevant to the topics of the tags. For example, a keyword search might match the search keyword with a keyword tag. A website can have tags and pages within a website can have their own tags. Thus, search engines often select individual pages of a website within a listing of search results.

Advertising revenue supports substantially every wellknown WWW search engine. Based upon the keywords of the search, selected advertisements appear on displayed pages of search results. Sometimes, advertisers appear in a separate column of web page listings. Selected advertisers often pay to be listed at the top of the results list.

An end user can access the World Wide Web and other resources running on the Internet by use of a local computer or workstation that is connected to a networked computer or server of the Internet. Typically, the networked server is administered by an Internet Service Provider (ISP), which is a business that offers Internet access via a paid subscription account. The ISP may provide other related services, such as email and hosting services for the user's website. The local computer runs a web browser. The user need know little about the Internet, as the complexity and protocols of moving through the networks is handled by the browser software. Often the user needs to know only how to find a search engine and enter search keywords. The ISP typically provides an opening web page to its subscribers, and this web page often includes hyperlinks to popular search engines. Thus, the search engine is a key feature that allows almost anyone, even those who understand little about the Internet, to locate and view resources on the Internet.

The search engine serves the essential function by organizing or indexing the body of data that otherwise is disorganized in the World Wide Web. The amount of data, web pages, and other resources on the Internet is growing in size at a rapid pace. The amount of information made available to a user by a keyword search can be overwhelming. A keyword search might return hundreds or thousands of web pages in the results listings. Even with the organizational advantage of a search engine, an end user frequently is challenged to select the most pertinent resources in the results listing. End users increasingly want and need the results listing to have improved clarity and precision, enabling faster and more accurate cursory review before the user selects which hyperlinks to follow.

Satisfactory management of search results is becoming increasingly difficult to achieve. A user may receive countless pages of resource listings, typically presented with ten resources per page. When the user is presented with such vast numbers of search results, certainly one common response to look no further than the first few listed web pages or perhaps to look at only the listings on the first page or two or resource listings. There is no assurance that the first listings are, in fact, the most pertinent; but the user is effectively prevented from further inquiry by overwhelmingly large size of the results listing and by the limited quantity of the user's own available time.

The search engine often contributes to this problem by needlessly expanding the size of the results list. Commonly, a search engine will list a same web page more than one time in a results list if the web page contains the search keyword at several different locations. Repeated display of the same web page is unnecessary and needlessly expands the results list.

The priority display of paid results listings also can degrade the user's ability to manage search results. While the advertisements may be critically important to the financial health of the search engine, the advertisements push the most pertinent search results further down the results list. In addition, users may learn to ignore the paid listings, which degrades the value of advertising and eventually can undermine the financial health of the search engine. What is needed is a paid listing display that is both distinguished from search results and of vastly improved value to the user. Such an arrangement revitalizes the value of advertisements to both the advertiser and the user, enhancing the financial health of the search engine.

It would be desirable to create a search engine that presents search results with improved clarity, enabling more accurate selection of pertinent hyperlinks. In particular, the human mind is able to grasp a great deal of information at one time, if the information is suitably presented. The present practice of displaying fragments of text containing the search keyword is inefficient and prevents the rapid management of the search result. The user is required to comprehend and evaluate the pertinence of a resource, based upon consideration of a text fragment. The difficulty of ascertaining a fair meaning from a fragment can lead to a needless time pause for consideration of each listed resource.

Further, since advertisements are an essential means of supporting the operation of search engines, it would be desirable to present advertisements with improved, attention-getting ability that is distinguished from search results.

To achieve the foregoing and other objects and in accordance with the purpose of the present invention, as embodied and broadly described herein, the method of this invention may comprise the following.

### BRIEF SUMMARY OF THE INVENTION

Against the described background, it is therefore a general object of the invention to provide a display of search results that presents entire websites from a hit list in streaming mode and provides paired advertisement that correlate to the search so as to supplement the content of the search result.

According to the invention, a search engine locates resources on a computer network in response to a search inquiry from any of a plurality of user stations on said network. Typically, as on the Internet, resources on the network are grouped into a plurality of host sites at diverse locations on the network with at least some of the plurality of host sites including sub-groupings of resources arranged as web pages that are linked by navigation internal to the host site. A resource locator address identifies the respective locations of the plurality of host sites on the computer network. A searchable archive of network resources contains selected data indicating host site content. The archive contains host site page content and the resource locator address of each of the plurality of host sites. The search engine provides an inquiry function receiving a search term inquiry from a user station on the network. A search function searching the archive of network resources and creates a hit list consisting of at least one identified host site that has correlation to the search term inquiry. A page selection function selects a hit web page from the archived host site, wherein the content of the hit page correlates with the search inquiry. The page selection function also identifies at least a second page within the archive of the host site, if present in the network resource archive. A search result reporting function simultaneously displays chosen parts of the identified website to the user station on the network. These chosen portions include the resource locator address of the identified host site and a selected portion of data from the archive of the identified host site. The data from archive includes an image of a hit page and an image of another page, if another page is present in the archive. As a result, the search engine delivers to the user station a search result including the resource locator address of the identified host site, an archived image of a hit page of the identified host site and an archived image of another page within the identified host site, if available in the archive.

In another aspect of the search engine, a searchable advertisement archive contains displayable advertisements having video and audio content. The search engine provides an opening web page having a search term input box displayed. The opening web page further provides a plurality of video display fields. An advertisement selector chooses advertisements from the archive of advertisements to populate the plurality of video display fields. An audio controller arranges the chosen advertisements in a series and sequentially plays audio content of the chosen advertisements in sequence to the user station.

In a further aspect, another page of the search engine reports the search results. On the results page, the search engine pairs each website of the results hit list with an advertisement from the advertisement archive. The search engine then displays the video content of the selected advertisement in juxtaposition to the search result for the paired website. Audio control is achieved by ordering the selected advertisements in series and supplying audio content of each selected advertisement in the ordered sequence.

The search engine reports search results as entire websites. A website on the hit list has at least one web page that counts as a hit. A hit-page-counter determines how may other pages within a website contain a hit and lists this result with links to the other hit web pages.

After the search engine has populated the image display fields of a search result with images of selected pages from the website archive, the search engine determine whether the web site includes additional pages. If additional pages are present in the archive, the search engine streams all pages of the archived website through the image display fields so that the entire website can be previewed from the search results page.

The invention also is a method of presenting a search engine and a hit list of search results. The method is applicable to a computer network in which resources are grouped into a plurality of host sites at diverse locations on the network. At least some of the host sites contain sub-groupings of resources arranged as web pages, which typically are linked by navigation internal to the host site. A resource locator address identifies the location each host site on the computer network. The search engine is in communication with a searchable archive of network resources. The archive contains data indicating host site content, including host site page content, and the resource locator address of each host site. The method provides a search term input field for receiving a search term inquiry from a user station on the network. The search engine then conducts a search by searching the searchable archive of website for the search term. The search produces a hit list of websites and also identifies at least one hit page within each archived website. From the archived version of each website, the search engine displays the resource locator address for the website, a text extract from a hit page, and a series of image display fields showing an image of an archived web page in each. One of the images is of a hit webpage. If the website is found to contain more pages than the number of image display fields, the search engine streams all pages of the website through the series of image display fields.

The search engine is in communication of a searchable advertisement archive of displayable advertisements having video and audio content. An opening web for the search engine provides a search term input field and a plurality of video display fields. The search engine populates the video display fields on the opening pages with advertisements from the archive of advertisements. The video display fields play the video content of the populated advertisements. In addition, the search engine orders the populated advertisements in a series and sequentially supplys the audio content of each advertisement in the order of the series.

On the search-reporting page, the search engine displays data extracted from archived websites on the hit list of search results. Archived advertisements selected are paired with websites on the hit list. The video content of the selected advertisements is displayed, juxtaposed to the extracted data from the paired website. The search engine orders the selected advertisements in a series and sequentially supplying audio content of each selected advertisement in the order of the series.

The search engine monitors and reports the number of hit web pages in each website of the search results. The related method is to count the number of hit pages within a host site on the hit list; determine whether the number of hit pages is greater than the number of hit pages displayed in image display fields for the search result of the selected host site, display the hit page count in a data field for the search result for the respective host site; and link the hit page count data field to the resource locator address of a hit page.

The search engine also streams images of every page in an archived website if the total number of pages in the website is greater than the number of image display fields. The related method is to display a preselected number of web pages from the identified host site in equal number to the number of image display fields; to determine whether the identified host site has more pages than the preselected number of image display fields; and to streaming all pages of the identified host site through the image display fields if the identified web site has more pages than the preselected number of image display fields.

The accompanying drawings, which are incorporated in and form a part of the specification, illustrate preferred embodiments of the present invention, and together with the description, serve to explain the principles of the invention. In the drawings:

### BRIEF DESCRIPTION OF THE SEVERAL VIEWS OF THE DRAWINGS

FIG. 1 is a flowchart showing login and display functions applicable to an opening page of search engine operation.

FIG. 2 is a flowchart showing search and advanced search functions applicable to an opening page of search engine operation.

FIG. 3 is a flowchart showing login and preferences functions applicable to a search results page of search engine operation.

FIG. 4 is a flowchart showing advanced search and search functions applicable to a search results page of search engine operation.

FIG. 5 is a flowchart showing display of commercials and sound selection functions applicable to a search results page of search engine operation.

FIG. 6 is a flowchart showing selection and hyperlink to search result websites and showing display of website text on a search results page of search engine operation.

FIG. 7 is a flowchart showing control and display of a total pages button on a search results page of search engine operation.

FIG. 8 is a flowchart showing control of streaming images from a website on a search results page of search engine operation.

FIG. 9 is a flowchart showing continuations of flowcharts from FIG. 8.

FIG. 10 is a schematic diagram showing a GUI with layout of functions on an opening page of a search engine website.

FIG. 11 is a schematic diagram showing a a GUI with first embodiment of the layout of functions on a search results page of a search engine website.

FIG. 12 is a lower continuation of FIG. 11.

FIG. 13 is a schematic diagram similar to FIG. 11, showing a second embodiment thereof.

FIG. 14 is a lower continuation of FIG. 13.

FIG. 15 is a schematic diagram similar to FIG. 11, showing a third embodiment thereof.

FIG. 16 is a lower continuation of FIG. 15.

FIG. 17 is a schematic diagram of the search engine in relation to the Internet.

### DETAILED DESCRIPTION OF THE INVENTION

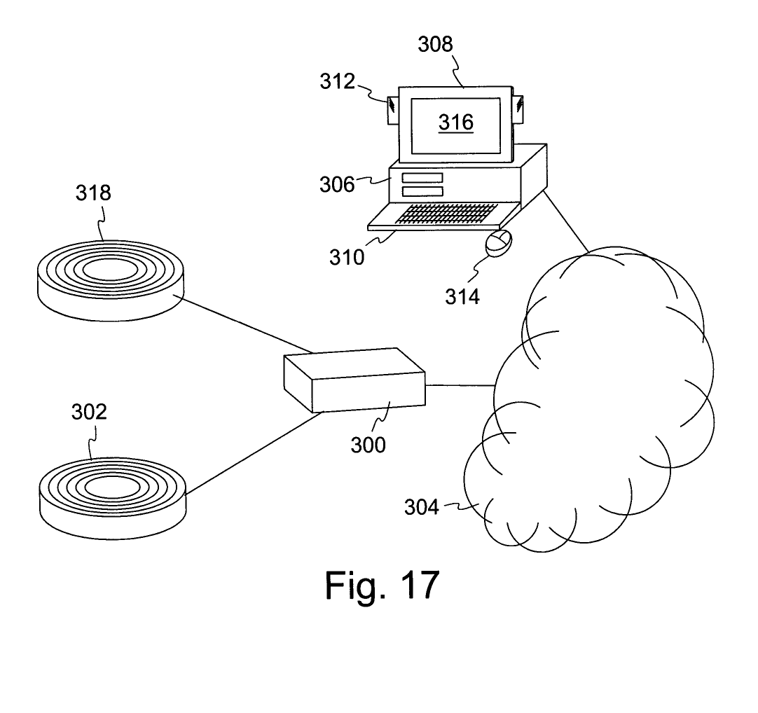

The invention is an improved search engine for finding and reporting network resources on a computer network, which may be composed of a plurality of servers and general-purpose computers. With reference to FIG. 17, the search engine is a software application that resides and runs on a server 300 or server farm within a computer network and employs an associated indexed archive or database 302 of archived, indexed resources running on a the network 304, such as the Internet.

The indexed resources of database 302 are known or indexed by identifying criteria such as hostname and resource locator address. On the Internet, a hostname is an individual domain name. Often a hostname can be characterized as a second-level domain on the Internet. Other hostnames can be characterized as subdomain names and vanity domain names. A vanity domain is a domain known by another name but aliased to a user account. The resource locator address, which is often called a URL, uses a domain name in combination with other identifiers. A URL is equivalent to, or translated to, the address of a resource on a network. On the Internet, the resource is known as a website. A website is a grouping of data at an identified location on a network. Thus, a website on the Internet can be defined as a location on the Internet network containing data at a location identified by a URL and named by a domain name.

A website can be broken down into sub-groupings of information, which are defined as web pages, typically common to a hostname or domain name. A web page refers to an information set that can be accessed through a web browser. A web page within a website may or may not have a static URL. A web page with static content may have a static URL, while a web page with dynamic content will not. For example, a search engine produces a dynamic web page of search results. The static or dynamic URL for a web page will be based upon the hostname or domain name for the website, with added information specific to the web page. A website opens with a front page or homepage when the URL for the second-level domain is followed. Remaining pages in the website typically are reached by internal hyperlinks.

A computer network consists of two, three, or more computers connected together by a communication system so that they can share resources. The Internet includes a countless number of computers. Some computers are known as servers, while others are known as workstations or dumb terminal. Server computers communicate and provide various types of services with other computers known as clients. Often a server is a full-time participant in a network such as the Internet, while client computers may vary in their time or degree of participation. Workstations are computers used by humans for such tasks as accessing a server, inputting data, and retrieving data. The ultimate user of a network such as the Internet is a human, typically accessing the network through a workstation, client computer, or the like. The term, user station, will generally refer to any type of computer, terminal, or other access point to a network, allowing a user to input and retrieve data. A user station typically will have a display screen for receiving data from the network in the form of pages or web pages.

In response to receiving a requested keyword search from another server or user station 306 on the network 304, the search engine locates resources that correlate with the search term by examining the archived contents of the network resource data bank 302. Correlation may refer to any scheme of processing a search inquiry to derive a search result. For example, the correlation may be exact, such as the discovery of the exact search term in a host site archived in the data bank 302. As other examples, search schemes may seek variations of the search term, such as plural or singular, various truncations or expansions, synonyms, roots, categorizations, and variations in spelling. The search may derive a search result by applying an algorithm or logical abstraction to the search inquiry.

The search engine identifies such relevant resources as may be found in the archive 302 and reports this result to the user station 306. The results are presented in an ordered list showing occurrences of correlations with the search term. The list will be called a hit list. Each occurrence of a correlation will be called a hit. A single website may contain one or more hits occurring on one or more web pages. For each hit, the search engine acquires the network address, such as the URL, from the archive. The search engine then returns a display of the hits for user review, together with hyperlinks to the websites and web pages containing the hits.

The search engine is useable by a human user at a user station, for example a general-purpose computer on the Internet. For example, a user on the Internet may communicate through a personal computer 306, also known as a PC, with central processing unit or CPU. Personal computers presently are identified as two popular types: one is IBM PC compatible, while the other is Apple Macintosh. Either type employs a computer interface with a video display 308 or video monitor screen, a text and numerical input device such as a keyboard 310, a sound output device such as audio chip and speakers 312, and a selection means such as a graphical pointing device, often referred to as a computer mouse 314, trackball, touchpad, or the like. Many of these devices have still more variants than those specifically named. References to general types of devices or to specific examples of the general types should be understood to be for purposes of example and not limitation.

The computer runs under control of suitable software, which includes an operating system. Examples of operating systems include Microsoft Windows, Unix, Linux, Mac OS X, and BSD.

The operating system controls many aspects of computer operation and provides and controls a graphical user interface (GUI) 316 on the computer display 308. Specifically, the GUI uses the graphical pointing device or mouse 314 to input information and to direct a mouse pointer or cursor on the computer display. The mouse pointer or cursor is a device that indicates an input-related position on a monitor screen. The GUI often provides buttons, icons, fields, or other selected locations on the display screen where the cursor can be located. The button, icon, field, or the like represents a computer file, folder, or software program.

The mouse 314 includes one or more buttons that can be pressed, referred to as a click, while the cursor is placed on the button or icon of the GUI to cause the operating system or other software to select, open, or actuate the represented file, folder, link, or program. This operation is generally known as clicking. A often has at least two buttons such that clicking can be broken down into right-clicking or left-clicking, each with different result according to software control. Clicking often is divided into single clicking and double-clicking. Single clicking often selects the icon presently at the cursor. Double-clicking often actuates or opens the file, folder, or program associated with the icon. On the Internet, an icon or button often is a hyperlink. Single clicking the icon or button on the Internet can be sufficient to select and actuate the hyperlink. Thus, a mouse 314 or other graphical pointing device under software control is a common example of a means for selecting a field or other content on the GUI and actuating a hyperlink associated with the field.

As a first improvement, the search engine displays the search result as images of archived web pages of a website containing hits. The images are small, known as thumbnail images or miniaturized screen shots. These thumbnail images are derived from database 302 and are generated on the computer display of the user station, typically a general-purpose computer.

The human brain can take in a large block of suitably presented information in an instant. For example, a fast reader comprehends an entire sentence rather than the individual words. In some cases, a fast reader comprehends an entire paragraph or an entire page in a single glance. Therefore, the presentation of an entire web page at one time offers a potential for vastly increasing the speed and accuracy of a user's comprehension of the search result listing. Even with imperfect comprehension of a thumbnail web page, the user should find an improved ability to determine whether following the hyperlink to the full web page is worthwhile.

Further, inquiry into a website frequently leads to more than one web page containing pertinent information, even if some of the other web pages are not selected as hits. In order to present the full range of pertinent information, the search engine identifies the website that contains a hit. The display of search results includes a series of image display fields or logical boxes. The search engine displays a plurality of archived pages of the website containing a hit, if such plurality is available, even if some pages do not contain a hit. The pages are simultaneously displayed in the search result as contents of a series of a predetermined number of image display fields. If the website contains more pages than the predetermined number of image display boxes, the archived pages of the website are presented as a streaming series of web page images of the website, advancing sequentially through the image display fields. The flow of streaming web pages allows the user to evaluate a still larger body of information without expending the time to visit the website. The user can better sort between search results and identify entire websites that are most pertinent to his search inquiry.

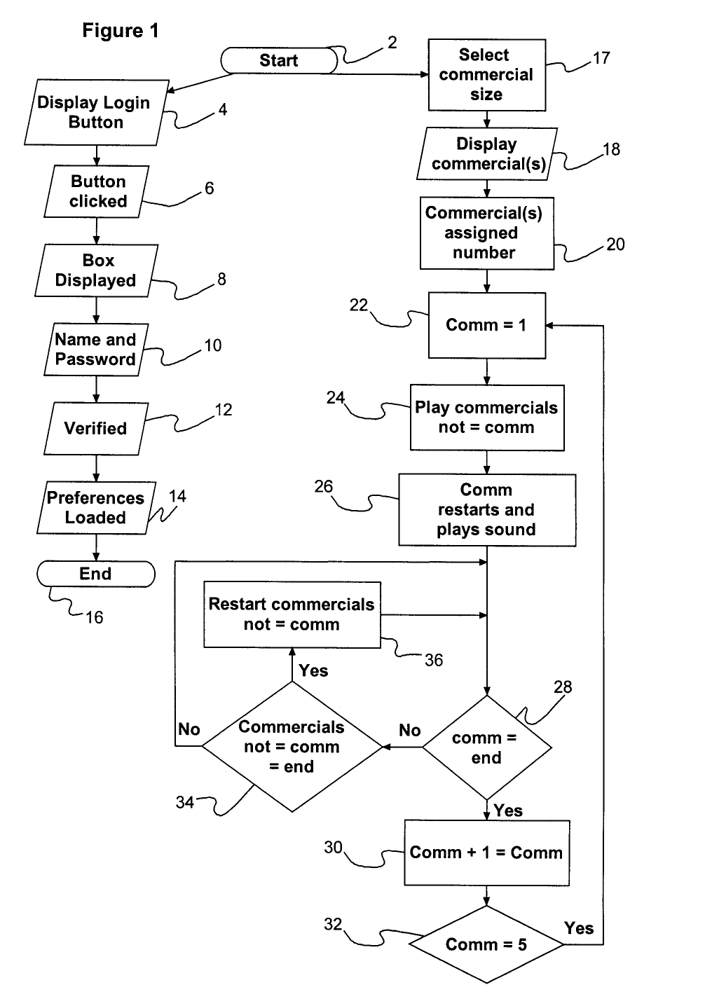

As an example of a search engine that can provide the described benefits, FIGS. 1-9 show the flow of a software program that delivers these benefits. A software program of this sort will be referred to as a search engine. The software program resides on a network such as the Internet and is a resource that runs on that network, such as a resource of the World Wide Web. Specifically, the software is reached at a website, which opens at a specific web page such as a homepage of the search engine. From the homepage, the software runs on the network in response to inputs from the user. A user wishing to employ this search engine can do so by accessing the website of the search engine, for example by entering the URL or IP address of the search engine website into a suitable browser. Perhaps more commonly, the user will reach the search engine by clicking a hyperlink found elsewhere, such as on a homepage of the user's ISP website.

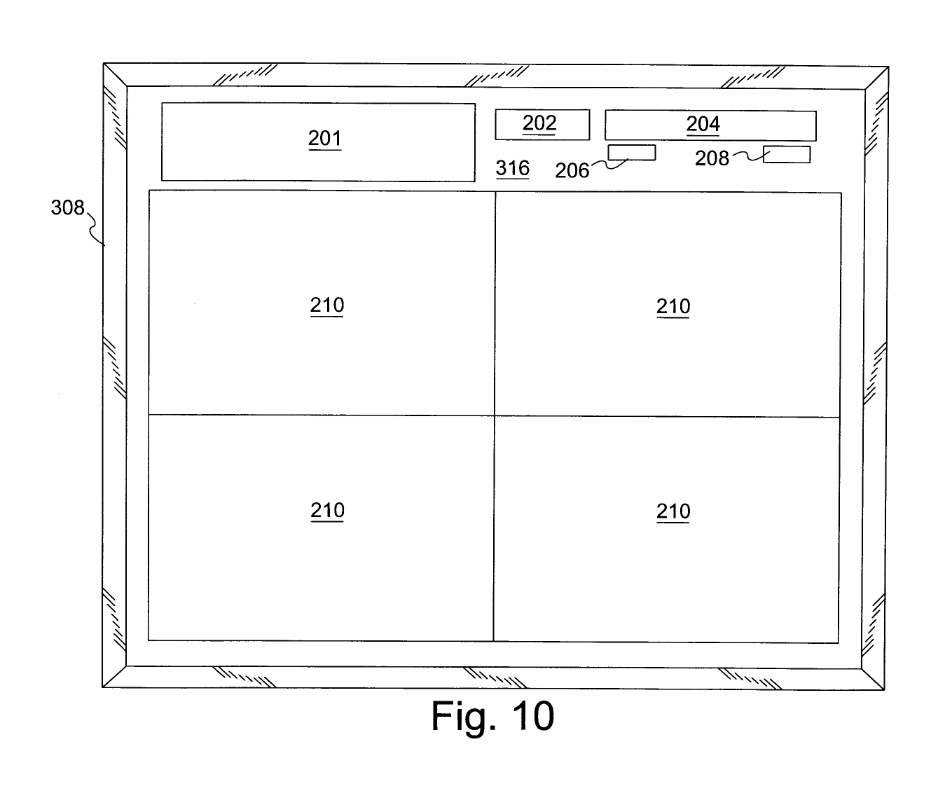

The search engine causes the display of search hits to be categorized and displayed by website. The display shows web pages of each archived website containing a hit. The search results are unique in their content and grouping. Various groupings in FIGS. 10-16 illustrate preferred arrangements of search results. Portions of each result are displayed in a plurality of fields that are arranged in a group or array. FIGS. 10-16 show groupings of data fields. The box images indicate the intended location of data by framing a representative area of the display screen. In use, the framed areas will have content. The box frame may be absent or invisible on an actual display screen.

An opening page or homepage of the search engine may display the content of FIG. 10. Across a page header, the opening page displays a title field 201, which may identify the search engine by a popular name. A next box 202 may be a button for initiating a search. Accordingly, the button 202 is labeled informatively, such as with the heading, “Quick Search.” Button 202 also directs the user to search term entry box 204 where a search term or keyword may be entered. Below the search term box 204, the page may list a “preferences” button 206 and an “advanced search” button 208. The “preferences” button 206 opens a page allowing the user to list or change his personal preferences, described below. The “advanced search” button 208 opens a page allowing the user to search using a special set of search criteria.

Below the header, the homepage provides an initially predetermined plurality of major commercial display fields 210. The size and arrangement of the display fields may depend upon the screen size and resolution of a visual display monitor 308 at a user station. Often, four display fields 210 will be arranged in a 2×2 matrix. As desired, or as determined by software analysis explained below, the fields 210 may be annexed to produce other arrangements, patterns, and resultant numbers of available commercial display fields. For example, two juxtaposed fields 210 in a single row may be annexed to form a single, wide field 210, producing a resultant three video display fields. Three resultant fields also may be achieved an annexing two juxtaposed fields 210 in a single column to form a single, tall field 210. The four fields 210 displayed in FIG. 10 may be annexed to form a resultant single large field.

Each available field displays a hyperlinked commercial movie clip from a database 318, preferably with audio and video content. In the context of this search engine, an advertisement or commercial is a video clip or short presentation in the mode of a motion picture. The video content of such a video clip is composed of individual pictures, scenes, or frames presented in sequence. A single frame has a file size of about two kilobytes or more. This file size and video content mark a significant departure from the common practice of displaying static or animated banner ads on search engines and web pages.

The search engine selects these advertisements from database 318 containing available advertisements. The advertisements may be associated with tags such as keyword tags to assist the search engine in selecting an advertisement. The database 318 archives advertisements by sponsors who have arranged to have their advertisements specifically displayed on the web pages of the search engine. An advertisement in a field 210 is hyperlinked to the advertiser's website on network 304. The user can advance directly to an advertiser's website on the network 304 by actuating the hyperlink, such as by clicking a field 210. These initially displayed advertisements are selected and displayed according to conventional practices, such as according to advertiser bid or contractual choices.

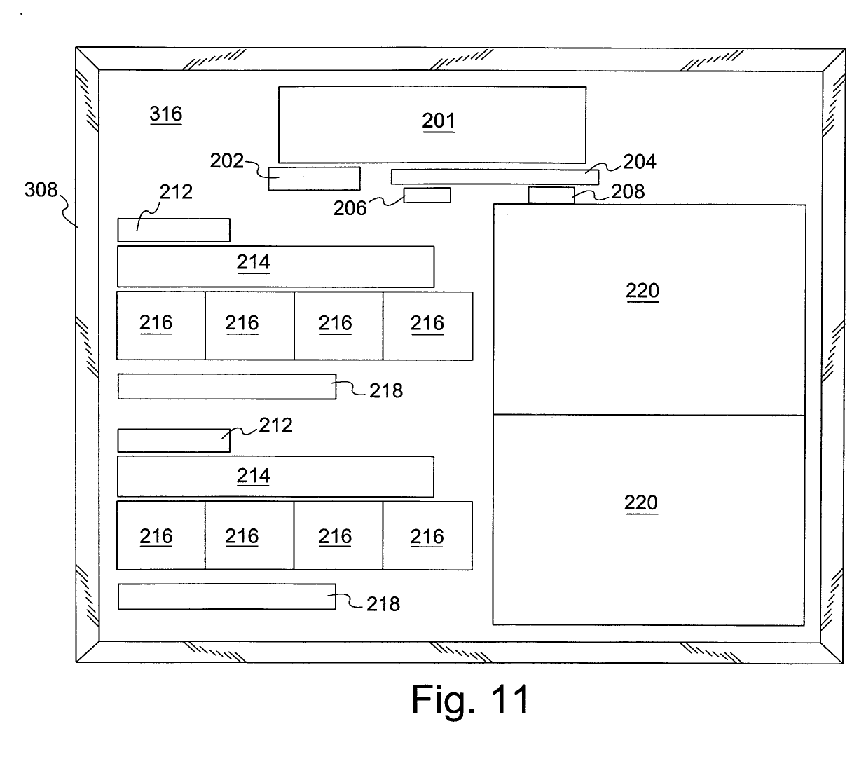

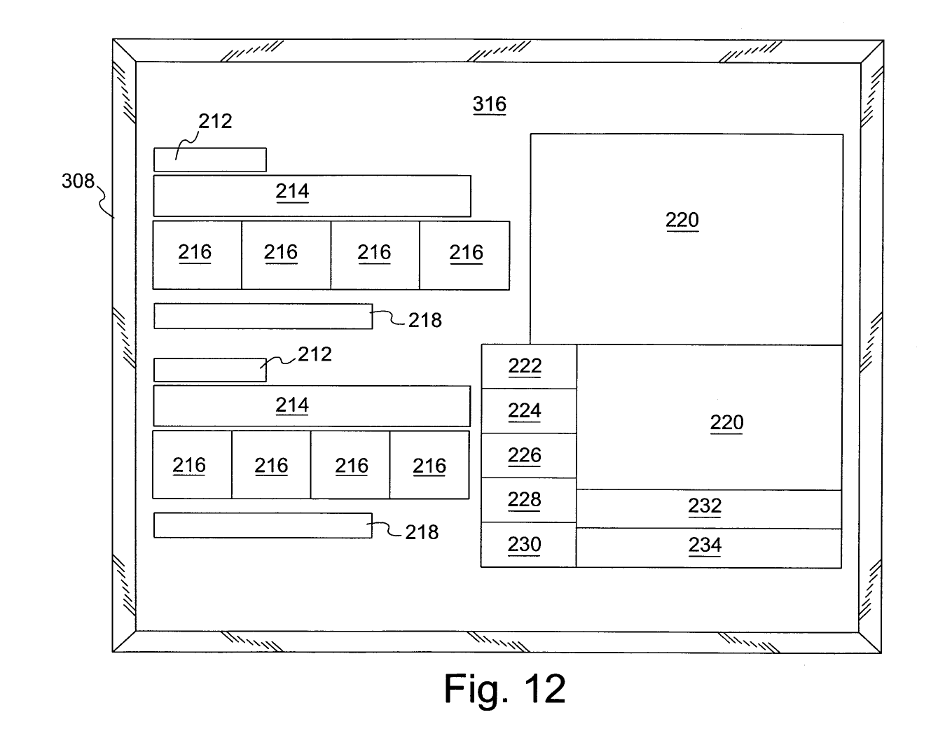

A second page of the search engine website is a search results page. In part, the page is assembled as a specific product of each search. FIGS. 11 and 12 show features of enduring content and arrangement of a search results page. FIG. 11 is the top half of the first search results page. The search results page may repeat the header boxes, such as boxes 201-208. Optionally, the positions of boxes 201-208 are varied as compared to the homepage header. Below these header boxes are a plurality of sets of fields arranged in groups or arrays. Portions of each archived website within the search results will appear in one array of fields. Each group of fields is dedicated to a unique website within the search results. Depending upon the keyword or search term that was employed for conducting the search, the fields of each group will display a combination of data derived from an archived website within the search result. The displayed data is obtained from database 302. Preferably, four websites from the results will be featured on each results page.

FIG. 11 shows two groups of fields suited for displaying search results related to two websites. For each of the two leading results, the search results page displays a website title at a respective field 212. The title may be hyperlinked to the website URL on network 304, if desired. In a text display field 214 below the title of each website, the search engine will list a text extract from the archived results website showing the language of the hit. Text display field 214 also will list the URL of the website on network 304, which is hyperlinked to the homepage of the results website on network 304.

In a plurality of streaming image fields 216 below the text display box 214, this archived website from the search engine results will be shown as thumbnail images of a like number of selected pages, as may be present from the archived website. If more pages are available than the number of fields 216, the available fields will display initially selected page images, and under software control, offer the capability of presenting the remainder of pages in the archived website as a streaming series such that pages of the website will be displayed in a sequence. One of the streaming image fields 216, such as the fourth or last of such fields in each series will be a hit box, which displays an archived web page that contains a hit from the search. This streaming image field will be highlighted to identify it as the hit box.

At optional hit count field 218, the search result will indicate the hit count of the website in terms of the number of pages containing a hit, in excess of the hit page displayed in the hit box. The hit count field may state the number of other pages in the website containing hits, if any. The hit count field 218 may be omitted as desired, and particularly is not needed for websites that have only one hit or hits on only one page, such as the page displayed in the hit box.

Finally, a major field 220 is located to the right of the streaming thumbnail images. In this field, the search engine will display a selected commercial, preferably as a video clip with capability to play sound. Unlike the random commercials shown in fields 210 on the homepage, the commercials in commercial player fields 220 are chosen for a relationship or correlation to the subject matter searched. Thus, the stored advertisements in database 318 may be associated with meta tags, advertising words, or other identifiers to allow selection of an appropriate commercial video clip. The correlation between an advertisement and a search inquiry may be the result of any series of steps or comparisons that is initiated by the search inquiry. Various possible comparisons are given, below, as examples and not as limitations.

Each website within the search results list may be accompanied by a unique advertisement in field 220. It is possible for an advertiser to have his commercial displayed along side his host site or website in a search results list, whenever his website arises in a search result. Thus, each website identified at a grouping of fields 212-218 may have its own commercial played at the adjacent fields 220, thereby taking maximum advantage of having been found in a search. All available advertisements may be stored on the advertisement database 318 and indexed for a variety of keywords or content-correlators that may arise in a search.

The advertisement that plays in juxtaposition to a host site within the search result may be selected based on any of several selection criteria. For example, an advertisement may be selected because it correlates with the search term. In that instance, the ordering of advertisements is based on factors other than the specific identity of the host sites selected as search results.

As another example, the advertisement playing in juxtaposition to a search result may be selected for a correlation with that specific search result. A host site selected as a search result may have its own meta tags or keyword tags. These aspects of the selected host site within the search result can be used to correlate with advertisements in the data bank 318. Similarly, the hostname or resource locator address of each selected host site in the search result provides a highly specific means of correlating the search results with the advertisements in data bank 318. An advertiser could arrange to have his advertisement play in juxtaposition to his own host site whenever his own host site appears in a search result.

As still another example, each web page of a website has its own subject matter identifiers such as its own meta tags or keyword tags. Therefore, the correlation between a search result and a displayed commercial can be keyed to the identifiers on a specific web page of a host site in a list of search results. A suitable strategy would be to identify a pertinent page of a website, based on the search inquiry from a user station on the network. The meta tags or keyword tags on the pertinent page then could be used as a basis to correlate with advertisements in database 318. This strategy would cause the selected commercial to be highly specific to the content of a pertinent page.

A further refinement can apply where an advertiser wishes to show a specific advertisement in conjunction with the selection of a web page from his own website. In many situations the advertiser presents a plurality of pages on his website, each with content directed to unique subject matter, such as a different product from the other web pages of the site. In this instance, the advertiser may cause his commercial playing in commercial player field 220 next to his website in the search results to correspond to a specific one of the streaming pages in fields 216. Thus, if the user one-clicks or right-clicks on one of the streaming thumbnails, the streaming sequence may freeze on the clicked page; and a commercial will play in field 220 corresponding to the exact subject matter or a keyword appearing on the clicked page. This correlation between a search result and an advertising video clip creates a substantial step forward in presenting pertinent information to the user. In addition, an advertiser gains an improved ability to present his specific product of interest to the most interested user. This combination is expected to add both value and interest to the Internet.

The first post-search page of FIG. 11 may continue as shown in FIG. 12, with a third and fourth website hits. The format of fields 212-218 may be repeated for these results. However, as an optional variation at any one of the results positions, shown by way of example at the fourth or last results position on the page, a video display field 220 can offer optional choices for content. At this optional or fourth position, preference buttons 222-234 border the field 220. The preference buttons are hyperlinked to information of the user's preferences. For example, the respective buttons may link to music 222, news 224, sports 226, stocks 228, weather 230, news tickler 232, and stock tickler 234. The user may select a preference, which will control the display in the optional or fourth position until the preference is changed by a different selection.

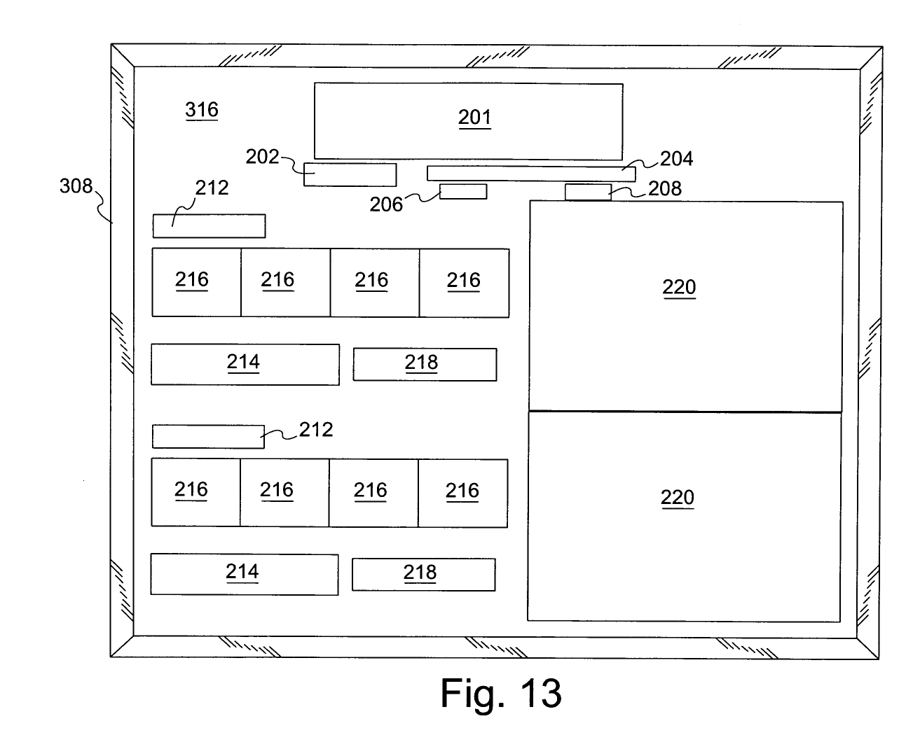

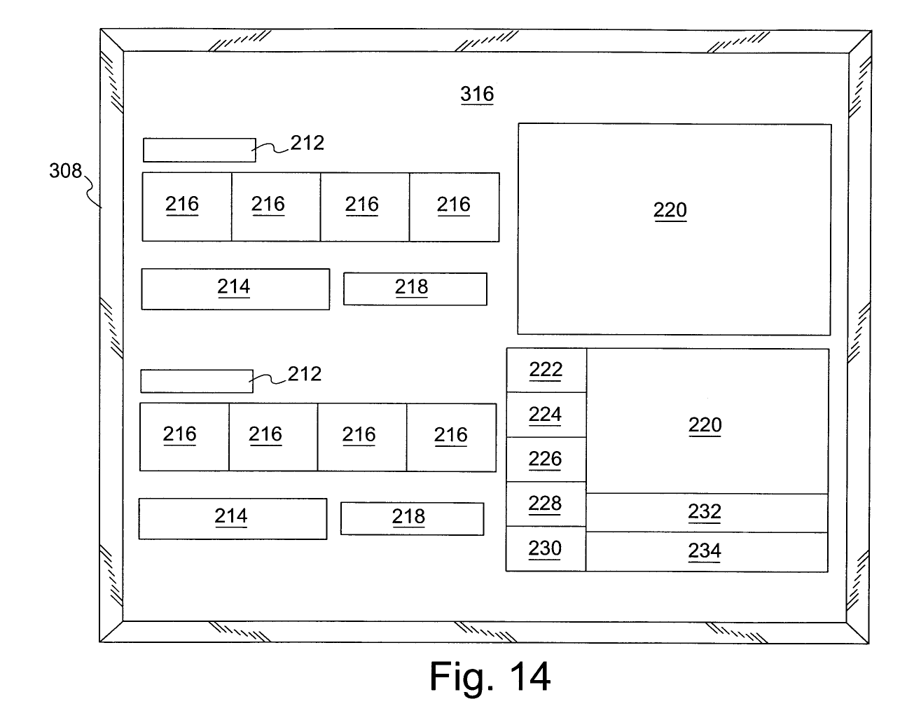

The grouped fields within each website hit display may be arranged in various other formats. FIGS. 13-16 illustrate these optional arrangements, continuing to employ the previously used identifying numbers for fields of substantially the same content or function. Thus, FIGS. 13-14 are a first variation of FIGS. 11-12. The header boxes 201-208 of FIG. 11 may remain substantially unchanged. Similarly, in the search results fields, title box 212 may continue to head the individual result array of boxes. The series of streaming thumbnail fields 216 may be advanced within the grouping to a position above text description field 214, and the text description field may be arranged side-by-side with the page count field 218. FIG. 14 carries forward this first variation to the results groupings of FIG. 13.

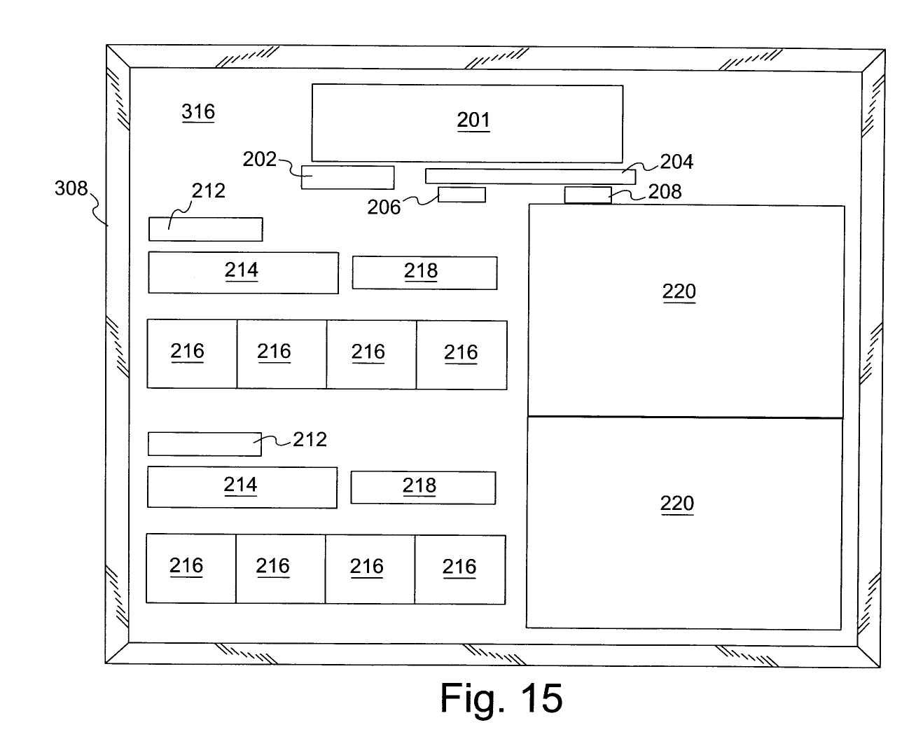

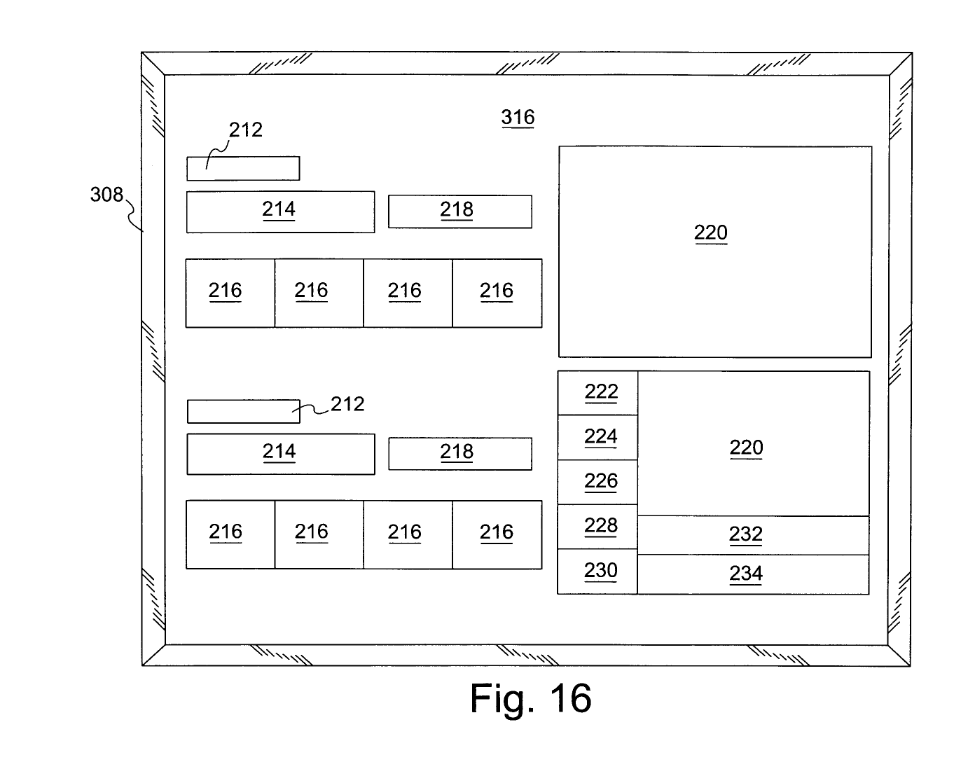

FIGS. 15-16 show a second variation of FIGS. 11-12. Header boxes 201-208 may remain substantially unchanged. In the search results grouping for each website hit, title field 212 continues to head the individual website hit grouping of fields. The text description field 214 and the hit count field 218 are placed side-by-side, with the former to the left of the latter. Field 214 and 218 are placed below the title field 212, and the streaming image fields 216 are relocated below the text description field 212 and hit count field 218. The commercial player field 220 remains a major field to the right of the streaming image fields 216.

The search engine software may run one or more processing routines or branches, according to choices received from the user station. The web pages that are displayed during routine operation of a search engine are of two types. A first type is the homepage or opening page, which is the page that a user station first reaches at the URL of the search engine. The second type is the search results page, which is the page that a user station next reaches after initiating a search from the homepage or from a search results page.

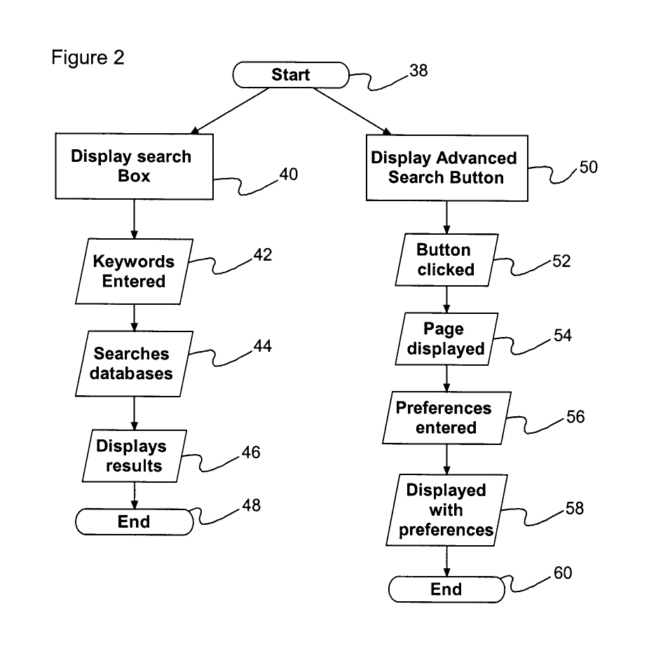

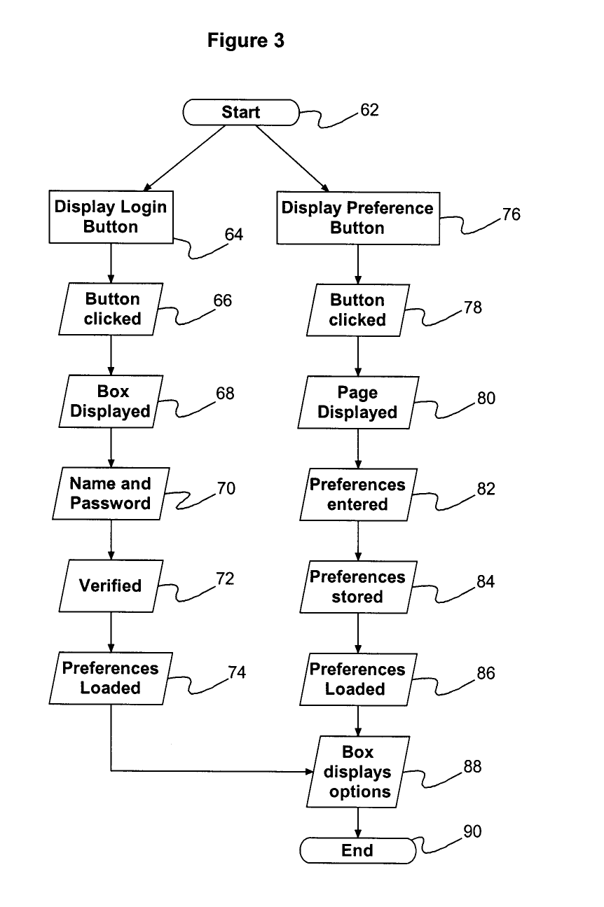

FIGS. 1-9 illustrate the various routines by showing logical steps or processing blocks. FIGS. 1-2 show processing sequences that are operative or available from the opening page or homepage of the search engine. FIGS. 3-9 show processing sequences that are operative or available from the subsequently displayed search results pages. The software communicates with the user station across the browser software running on the user station, presenting images, hyperlinks, sound files, and other types of resources. The user station receives and displays or plays the resources via the browser, visually seeing certain visible content on a computer display 308 or monitor screen and hearing audio content on speakers 312, all associated with a general-purpose computer station 306.

Optionally, the search engine provides a registration or recognition of each user. This can be accomplished in any of several ways. According to known logical systems, a user can register with a particular website or software program. Registration typically entails selecting a login name and password. Often, registration allows the application to record additional information about the user, such as various personal preferences, mailing address, and credit card information.

The homepage or opening page of the website hosting the search engine allows the search engine to recognize users who have registered. The search engine optionally follows the processing steps in the left hand column of FIG. 1. After starting at block 2, the software presents a login button at block 4, via the GUI. The user can move a pointer or cursor under control of a computer mouse to the location of the login button. Placing the cursor on the displayed login button, the user can click the login button at block 6. Clicking the login button causes display of a login box at block 8. The user can enter a username and password into the login box at logical block 10. This information is submitted to the search engine over the network, typically by further clicking the login box or other submit button. The search engine receives the login information and compares it with a database of known or registered users. A known user is verified at block 12. The search engine than loads previously entered and stored personal preferences of the known user at block 14. This login portion of the software ends at block 16.

Another method and means of recognizing a prior user is by use of a web cookie or HTTP cookie. A web cookie is a fragment of data. A server 300 on a network 304 sends the cookie to a web browser on the user station 306, where the cookie is stored. In turn, the web browser sends back the text fragment of data to the server 300 each time the browser accesses the server 300. The content of the cookie can identify the user station 306 to the server and may carry further information, such as a user preference.

As shown in the right hand branch of the logical flow of FIG. 1, at the main page, the search engine software can operate with or without the login function. Starting at block 2, the software initially prepares to display a predetermined number of video display fields, each displaying a selected commercial. An optional initial analysis at block 17 determines or redetermines the number of fields 210 that will be available for the display of commercials. This optional analysis may consider factors such as the file size of a commercial, advertiser's preference and instructions, download speed over the network, user station screen size, and user station screen resolution. The result may be the same number as the initially predetermined number of video display fields; or the result may be a smaller number. The result from the block 17 analysis determines who many video display fields will be displayed for a specific cycle of the search engine. If the number is less than the predetermined number commercial display fields, some of the juxtaposed video display fields will be annexed so that the screen at the user station is suitably filled. The resultant number of video display fields will dictate, in part, how many commercials are displayed to the user station at the opening page of the search engine.

At block 18, the appropriate number of commercials is displayed. These are the initial commercials displayed at fields 210 of FIG. 10. The choice of initial commercials may involve various selected criteria, including a rotation among advertisers. A plurality of commercials greater than the number of available fields 210 may be available from advertisements database 318. The software routine at the right column of FIG. 1 controls the play of commercials by first selecting and displaying the number of commercials corresponding to the number of available fields 210.

It is desirable to play commercials with sound. Method and means for controlling sound are implemented by a software routine that selects one of the commercials to play with sound and then rotates the sound feature among the available commercials, if more than one commercial is being displayed simultaneously. As indicated at block 20, each commercial is assigned a sequential number, such as a number from one to four. At block 22 a variable, which will be referred to as Comm, is assigned a value of one. At block 24, the software routine is caused to play the commercials, if any, not equal to the value of variable Comm, but without sound. Then, at block 26, a commercial with assigned number equal to variable Comm is restarted and played with sound. Thus, initially commercial number one is played with sound.

At block 28, the software tests whether the value of variable Comm is equal to end, meaning that the software checks whether the commercial playing sound has ended. If yes, processing advances to block 30, where the assigned value of Comm is increased by one, such that Comm plus one equals a new value of Comm. The new value may be two, which selects commercial number two, if present, to play with sound. At block 32, the routine checks whether all commercials have played with sound, by checking whether variable Comm is equal to one more than the available number of fields 210. For example, with four fields 210, block 32 checks whether Comm equals five. If the result at block 32 is yes, variable Comm is reassigned a value of one at block 22 and the sequence of commercials playing sound is repeated. In the extreme case, if only one commercial is being played, the single commercial plays with sound, repeatedly.

At block 28, if the value of Comm is not equal to end, processing advances to block 34 where the routine checks whether the value of commercials not equal to Comm is equal to end. Thus, the routine checks whether any commercials not currently playing sound have ended. If any has ended, processing advances to block 36 where these commercials are restarted. From block 36, processing will cycle back to block 28 to recheck whether commercial Comm has ended. Likewise, if at block 34 the commercials not currently playing sound have not ended, processing loops back to block 28. Thus, the commercials in the fields 210 will play with rotating audio, which advances to a next one of the displayed commercials when the last audio commercial has completed its run. The commercial with sound playing is allowed to run its full length.

FIG. 2 shows a method and means for operating a search or advanced search function from the homepage or opening page of the search engine. The search function follows the left hand column of logical steps in FIG. 2. The search function starts at block 38 by displaying a search term entry box at block 40, such as box 204 of FIG. 10 on the GUI 316. From the user station, a user enters selected keywords at block 42, typically from the keyboard or from a drop-down list of selectable keywords that may be supplied from the search engine or from keywords previously searched and stored in memory at the user station 306. At block 44 the search engine searches its databases or data banks 302 for the search term.

The search databases 302 may be those acquired in the conventional manner by a web crawler or spider that examines the network 304. However, the database 302 may be unique by its organization and content, according to the software controlling the web crawler. Typically the search database 302 will contain images of web pages and websites on the network, such as images of the available resources of the World Wide Web running on the Internet. Websites and web pages also have tags indicating content, which the database 302 contains in accessible form. The search results are displayed according to a display format such as those disclosed in FIGS. 11-16 for the display of search results.

The processing routine shown at the right column of FIG. 2 demonstrates a method and means for operating the advanced search routine initiated by button 208 of FIG. 10. From a start at block 38, the software routine displays the advanced search button on the GUI according to block 50. If the user clicks the advanced search button at block 52, a hyperlink directs the browser software to an advanced search page at block 54. The advanced search page receives the user's search preferences, such as the user may elect to enter at block 56, and stores these search preferences in memory at the user workstation 306. Thereafter, the search page is displayed according to the user's stored search preferences, at block 58. The advanced search routine ends at block 60.

FIG. 3 illustrates the method and means for entering of personal preferences, available from a search results page of the search engine. From software starting at block 62, an optional, modified logical flow follows the left had processing column, similar to steps 4-14 of FIG. 1. The search engine displays a login button at block 64; the button is clicked at block 66, and the login block is displayed at block 68. The user enters name and password at block 70, and these are verified at block 72. Finally, at block 74 the user's personal preferences are loaded and the search box then displays or plays the selected options, at block 88. Some of these personal preferences may relate to the selection of feature buttons 222, 224, 226, 228, 230, 232, and 234 on the search results pages.

Without a login routine, personal preferences are entered and played according to the right hand column of FIG. 3. After the processing routine starts at block 62, block 76 displays the preference button 206, FIG. 1. The user clicks the button 206 at block 78, causing a preferences page to be displayed at block 80. The user at user station 306 enters his personal preferences at block 82, and these are stored temporarily at block 84. The routine loads the preferences to the search page at block 86, with the result that the preferences box displays or plays the selected options at block 88. These options may relate to the selection of buttons 222-234, previously described. Processing ends at block 90.

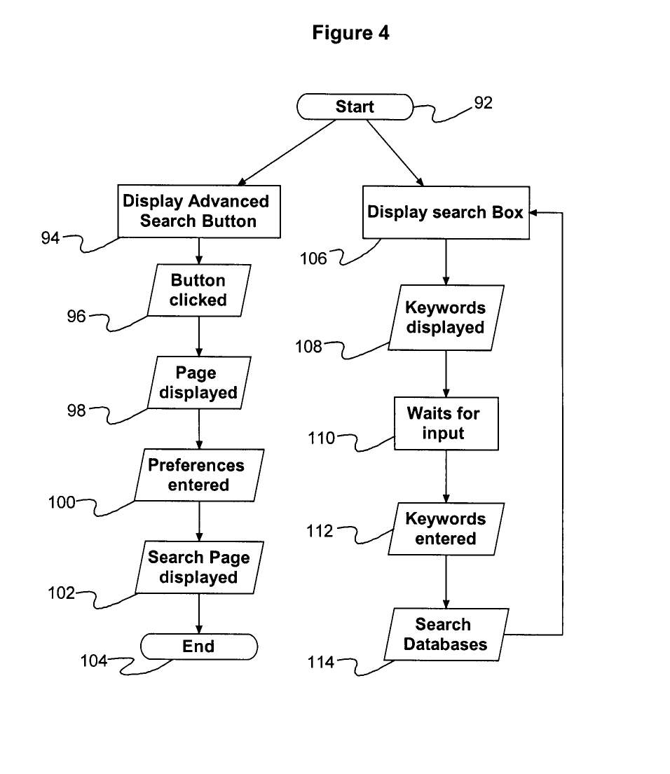

According to the flow of the left hand column of FIG. 4, the search results page provides a logical routine actuated by the advanced search button 208, FIGS. 1,13, or 15. After starting at block 92, the logical routine displays the advanced search button at block 94. If the user clicks the button at block 96, the routine displays an advanced search page at block 98. The user is allowed to enter advanced search preferences at block 100, and these are stored. Thereafter, the search page is displayed at block 102 with the stored advanced search preferences are displayed or played. Advanced search button processing ends at block 104.

According to the flow of the right hand column of FIG. 4, search term entry box 204, FIGS. 10, 11, 13, or 15 provides a search function. After starting at block 92, the software routine displays the search term entry box 204 at block 106. The user enters any desired keyword or search term from a suitable input device 310, and these keywords are displayed in the search term entry box at block 108. The processing routine may await further input from the user at block 110. The user subsequently may enter more keywords at block 112. When the user is finished entering keywords, he may click the quick search button 202 to initiate a search in archived network resources at database 302 for correlations to the keywords at block 114. Upon completion of the search, the software routine returns to block 106 to display the search term entry box 204 on any of the search results pages, as shown in FIGS. 11, 13, and 15.

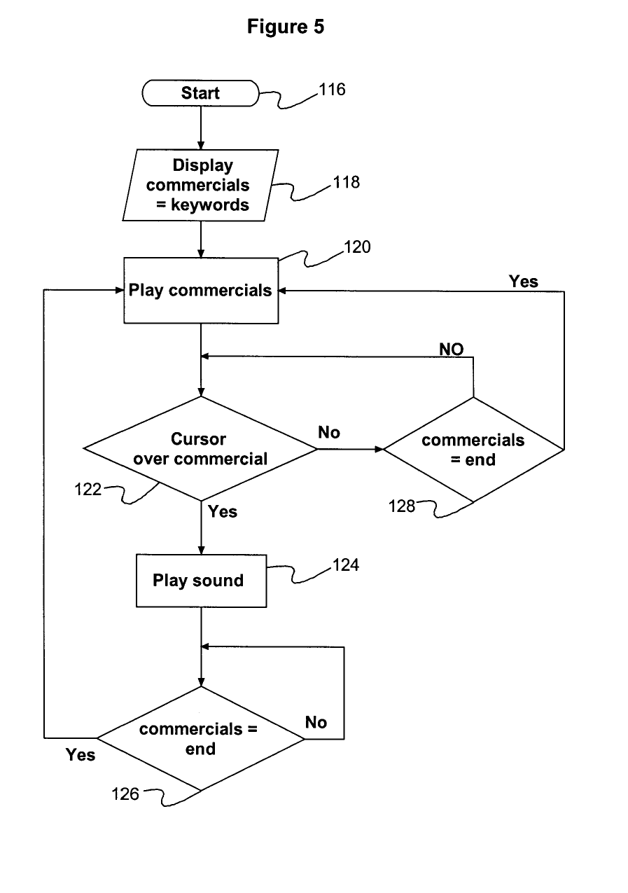

FIG. 5 shows a method and means of selecting and controlling commercials to display in viewer fields 220 on the search results page, based on search keywords. After starting at block 116, the routine advances to block 118 where available commercials in a database 318, FIG. 17, are selected for play. The selection may take place in several ways. One technique for selection is to correlate keywords, such as keywords used as search terms, keywords associated with each archived commercial, and keywords associated with each archived website or web page within the search results. The search keywords provide a readily available basis for seeking correlation. However, the websites and web pages found in the search also have keyword tags, which enables a commercial to be correlated with a keyword tag of a website or web page found in the search results. Thus, it is possible to select and pair a commercial to run in juxtaposition to one of the search results. The commercial can be specifically chosen to accompany that website or web page. Further, the text content of a web page also can be searched to find correlation with a commercial. The play of selected commercials begins at block 120.

The user is given the option of designating any commercial of those displayed in a viewer field 220 to also play audio content, allowing the user to hear sound. Thus, at block 122 the routine checks whether the used has selected a commercial, such as by placing the cursor over a viewer field 220. If no, processing advances to block 128 to check whether the commercials have ended. If the commercials have not ended, block 128 returns to block 122 to continue checking for placement of the cursor over a commercial. If the commercials have ended, processing advances from block 128 to block 120 to restart playing the commercials.

If the cursor is over a commercial viewer field 220, FIGS. 11-16, the sound for the commercial displayed in this field plays according to block 124. Block 126 continuously checks for the end of the commercial with sound. If no, checking continues. If yes, processing returns to block 120 and all commercials play again in the commercial viewer field 220.

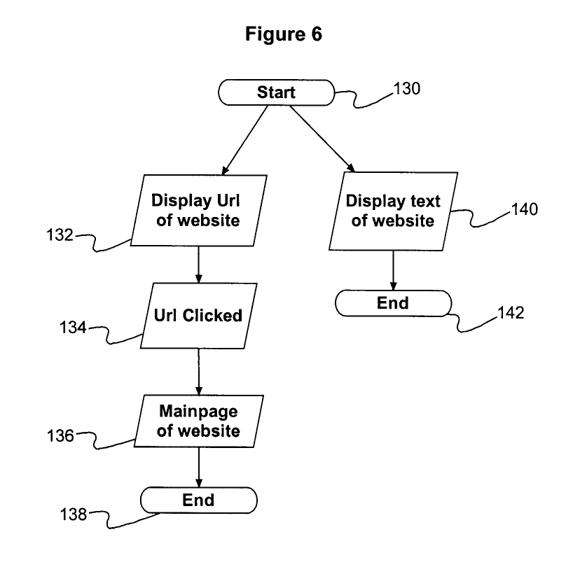

An additional function available from the search results page is to allow the user to view or visit the listed web pages on the network 304. The left hand column of FIG. 5 shows the processing to enable this function. The routine starts at block 130 and at block 134 displays the URL of a website in the results. The URL can be hyperlinked at any of fields 212-218 of the search results of FIGS. 11-16. The user can click the URL by clicking the hyperlink. The browser or search engine brings up the main page of the website as found in network 304 at block 136, and processing ends at block 138. At the right hand column of FIG. 6, the processing routine started at block 130 also displays text of the websites in the search results, such as at text display field 214 of a search results grouping in FIGS. 11-16. The text typically is extracted from the database 302 of archived websites, previously described. Text display processing ends at block 142.

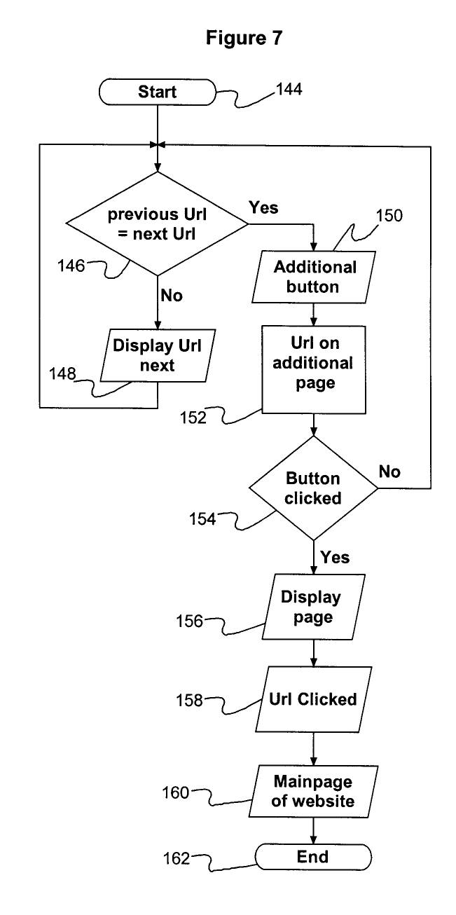

In the display of search results, the search engine determines for each resulting website whether more than one page of that website contains a hit. Additional pages are indicated at field 218. The sequence for determining the need for an entry in field 218 begins at block 144 of FIG. 7. At block 146, a counting sequence for hit pages checks whether the previous domain name of the URL of a search result is equal to the domain name of the URL. This inquiry indicates whether the same website had more than one page with a hit. If yes, at block 150 the search engine displays the additional hits button 218 with a hyperlink to the IP address of the further pertinent page. If the previous URL is not equal to the next URL, at block 148 the search engine creates a results listing for the next website as the next search result. The routine loops back to block 146 for continued checking.

When the search engine has displayed the additional-hits-button at block 150, it checks at block 154 whether the button is clicked. If no, processing loops back to block 146 to continue checking URLs. If the additional-hits button has been clicked, the search engine follows the hyperlink to the additional hit page at block 156. If the URL for the website is clicked at block 158, then at block 160 the search engine displays the homepage of the selected website from network 304. Processing ends at block 162.

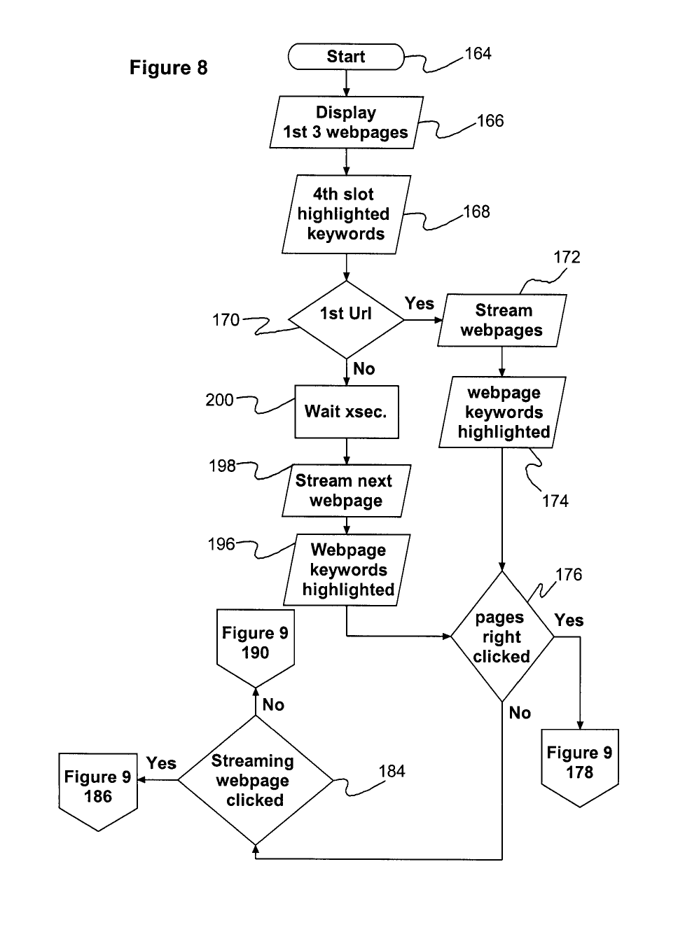

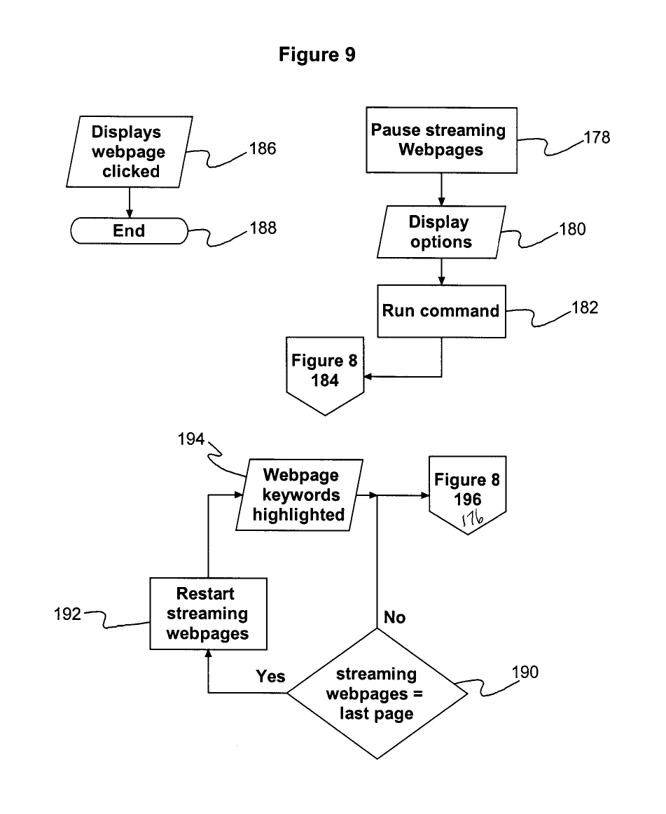

The search engine streams the archived web pages of each website from the search result in a group of image fields 216, FIGS. 11-16. Preferably, there are four image fields 216 for each website identified as containing a hit. Other numbers of fields 216 could be used, with suitable adjustment to the following description. FIGS. 8 and 9 shows the processing sequence for displaying the streaming web pages of each website in the hit list. The routine starts at block 164 and at block 166 selects and displays the first three web pages of a selected website from the hit list. In this example, the reference to three pages also is one less page than the total number of fields 216 for that single search result. These three web pages are displayed in the first three fields 216 of a series of four image fields. The web pages are selected from the URL of a website on the hit list.

One of the image fields 216 is designated as the hit box and will contain an archived image of a web page qualifying as a hit. At block 168, web page selection routine selects an appropriate web page from the hit website for display in the fourth or last image field 216, which is designated as the hit box, at the right end of the series of image fields in the views of FIGS. 11-16. This final web page is highlighted and is a web page that contains a specific hit. The highlighted web page is selected from the archived website having the URL identified in the search. Thus, in a display of four web pages from a single archived website, the fourth web page is a specific web page containing a hit, while the prior web pages are other web pages of the website containing a page with a hit.

At block 170 the routine examines the list of URLs of the search results to determine whether the presently displayed search result is from the first URL of the search results. If yes, processing advances to block 172 where the routine streams the remainder of the web pages from the archived website from database 302 having the first URL. The search terms or keywords are displayed as highlighted in the streaming display as an aid to identification, as implemented at block 174.

From block 170, if the URL is not the first URL, then the routine pauses for a selected interval at block 200 before streaming the pages of the next hit website at block 198. The keywords appearing on streaming pages of the next hit website are highlighted at block 196.

At block 176 the routine checks whether any of the streaming web pages have been clicked, such as by a right click to pause the streaming. If a page image has been right clicked, processing advances to block 176, FIG. 9, where the streaming flow is paused. Then, at block 180, the routine displays several available options to the user. These options might be to enlarge the image of the clicked web page or to view the text description of the clicked web page. Another option is to rewind some number of web pages, such as four web pages, in order to replay them in streaming order. Still another option is to skip to the last web pages, such as to stream the last four web pages of the website. At block 182, the routine runs the chosen option, and processing advances to block 184, FIG. 8.

The search engine provides a page location function for locating, retrieving, and displaying a selected page from the network 304. From either block 176 or block 182, processing advances to block 184, where the routine checks whether the user station has selected or clicked on an image viewer field containing a streaming web page from database 302 in a manner actuating the search engine to retrieve and display the selected web page. For example, the routine checks whether the user has placed a mouse pointer on the GUI 316 over an image viewer box 216 and left-clicked a mouse button. If so, processing advances to block 186, FIG. 9, where the corresponding clicked web page from network 304 is located, retrieved, and displayed; and processing ends at block 188. When a page is selected from a streaming series, the search engine locates the selected page as available on the network 304. The search engine follows the URL of the website containing the selected page and then follows such internal navigation of the website, as necessary, to reach the selected page and retrieve it. The actual selected or clicked page is displayed to provide the current content of the page on network 304 and is not restricted to the stored representation in database 302. Neither does the routine necessarily revert to the homepage of the website containing the selected page, unless the homepage is the selected page.

If a streaming web page is not clicked at block 184, processing advances to block 190, FIG. 9. There, the routine determines whether the streaming web pages have reached the last page of a website. If so, the sequence of streaming web pages is restarted at block 192 with keywords highlighted at block 194. From block 194, or from block 190 if the streaming web pages have not reached the last page, processing loops back to block 176 to determine whether a page has been right clicked, and continues from there.

The described search engine operates to provide improved efficiency and better presentation of information to the user. The strategy of presenting expanded content of websites provides for efficient and expedited exploration of surrounding data when the search has located a pertinent page.

The associated advertisement running in a field 220 is selected from a database or archive 318 of available advertisements. The sponsors of those advertisements may arrange for the selection and display of an advertisement in response to defined criteria. Possible criteria are correlation between a keyword tag on the advertisement and the search term. Other criteria might be a correlation with a tag, title word, or other identifier of a hit website. Further criteria might be a correlation with a keyword or other identifier of a hit web page. It would be desirable to select the advertisement by a correlation with a website or web page from the search results, so that the advertisement can be played in juxtaposition with that specific website or web page. Likewise, it would be desirable to select the advertisement by a correlation with the highlighted web page in the hit box of streaming images boxes 216. Such specific correlation would allow pinpoint precision is presenting supplemental information about a product or service that might appear on only one web page.

The foregoing is considered as illustrative only of the principles of the invention. Further, since numerous modifications and changes will readily occur to those skilled in the art, it is not desired to limit the invention to the exact construction and operation shown and described, and accordingly all suitable modifications and equivalents may be regarded as falling within the scope of the invention as defined by the claims that follow.

What is claimed is:

1. A search engine for locating resources on a computer network in response to a search inquiry from any of a plurality of user stations on said network, wherein resources on the network are grouped into a plurality of host sites at diverse locations on the network with at least some of said plurality of host sites including sub-groupings of resources arranged as pages that are linked by navigation internal to the host site, and a resource locator address identifies the respective locations of the plurality of host sites on the computer network, and wherein a searchable archive of network resources contains selected data indicating host site content, including host site page content and the resource locator address of each of the plurality of host sites, the search engine comprising:
inquiry means for receiving a search term inquiry from a user station on the network;
search means for searching said archive of network resources and creating a hit list of at least one identified host site having correlation to said search term inquiry;
page selection means for selecting a hit page of said identified host site correlating with said search inquiry and for identifying at least a second page within the identified host site, if present in the network resource archive;
search result reporting means for simultaneously displaying to the user station on the network at least the following data for said identified host site:
the resource locator address of the identified host site; and
a selected portion of data from the archive of the identified host site, including an image of said hit page and an image of said second page, if a second page is present in the archive;
whereby, the search engine delivers to the user station a search result including the resource locator address of the identified host site, an archived image of a hit page of the identified host site and an archived image of another page within the identified host site, if available in the archive.

2. The search engine of claim 1, further comprising:
a searchable advertisement archive of displayable video clips having audio content;
wherein said inquiry means further comprises:
a first search engine web page including a search term input box displayed to a user station accessing the search engine and a selected number of video display fields;
video control means for selecting a number of video clips from said advertisement archive in like number to said selected number of video display fields and for displaying the video content of said selected video clips in said video display fields on said first web page; and
audio control means for ordering said selected video clips in a series, if more than one, and sequentially supplying audio content of the selected video clips in said series to the user station.

3. The search engine of claim 1, further comprising:
a searchable advertisement archive of displayable advertisements having video and audio content;
wherein said search result reporting means further comprises:
advertisement selection means for selecting an advertisement from said advertisement archive by correlation with said search term inquiry and for displaying the video content of said selected advertisement in juxtaposition to said displayed data for said identified host site.

4. The search engine of claim 3, wherein said hit list identifies a plurality of host sites, said page selection means identifies said hit page and second pages with respect to said plurality of host sites, said search result reporting means displays images of said hit page and second page for the plurality of the identified host sites; and said advertisement selection means selects advertisements and displays video content of said advertisements in juxtaposition to the plurality of the identified host sites, further comprising:
means for ordering said selected advertisements in series and supplying audio content of each selected advertisement in said ordered series to the user station.

5. The search engine of claim 1, further comprising:
hit page counting means for counting the number of pages containing hits within a host site on said hit list; and
wherein said search reporting means further comprises a display of a hit page count from said hit page counting means.

6. The search engine of claim 1, wherein:
said search result reporting means comprises a display containing a plurality of image display fields in preselected number, each capable of displaying an image of a web page from said identified host site; and
further comprising a web page selection means for displaying a preselected number of web pages from the identified host site in equal number to said preselected number of image display fields, for determining whether the identified host site has more pages than the preselected number of image display fields, and for streaming all pages of the identified host site through the image display fields if the identified web site has more pages than the preselected number of image display fields.

7. A method of presenting a search engine and hit list of search results to a user station on a computer network, wherein resources on the computer network are grouped into a plurality of host sites at diverse locations on the network with at least some of said plurality of host sites including sub-groupings of resources arranged as pages that are linked by navigation internal to the host site, a resource locator address identifies the respective locations of the plurality of host sites on the computer network, and the search engine is in communication with a searchable archive of network resources containing selected data indicating host site content, including host site page content and the resource locator address of each of the plurality of host sites, comprising:
providing a search term input field for receiving a search term inquiry from a user station on the network;
conducting a search by searching said searchable archive for the search term; and
producing a hit list of search results from the searchable archive, identified by host site and by a hit page within each host site;
providing a search reporting page showing at least a portion of the search hit list, simultaneously displaying to the user station on the network at least the following data in grouped fields for an archived selected host site on the hit list:
the resource locator address of the selected host site;
a text extract from an archived hit page within the selected host site;
a series of at least two image display fields, displaying an image of said archived hit page in one field and displaying an image of a second archived page of the archived selected host site in a second field, if a second page is present in the archive;
determining whether the archive of the selected host site contains pages in addition to said hit page and second page; and
if additional pages are present, displaying all archived pages of the selected host site in said series of image display fields in a streaming series of pages.

8. The method of claim 7, wherein the search engine is in communication with a searchable advertisement archive of displayable advertisements having video and audio content, further comprising:
providing a first search engine web page including said search term input field and a predetermined plurality of video display fields;
selecting from said advertisement archive a plurality of advertisements in like number to said predetermined plurality of video display fields;
displaying the video content of said selected advertisements in said video display fields on said first web page;
ordering said selected advertisements in a series; and
sequentially supplying audio content of the selected advertisements to the user station in the order of said series.

9. The method of claim 7, wherein the search engine is in communication with a searchable advertisement archive of displayable advertisements having video and audio content, and said search reporting page displays grouped data fields for each of a plurality of selected host sites on the hit list, further comprising:
selecting from said advertisement archive a plurality of advertisements, equal in number to said plurality of selected host sites, wherein the advertisements are selected by correlation with said search term inquiry;
pairing each selected advertisement with a host site from the hit list;
displaying the video content of each selected advertisement in a display field juxtaposed to the grouped fields for the paired host site;
ordering the selected advertisements in a series; and
sequentially supplying audio content of each selected advertisement to the user station in accordance with the ordered series.

10. The method of claim 7, further comprising:
counting the number of hit pages within an archived host site on said hit list;
determining whether the number of hit pages within the archived host site is greater than the number of hit pages displayed in the image display fields for the search result of the selected archived host site;
displaying the hit page count in a data field for the search result for the respective archived host site; and
linking the hit page count data field to the resource locator address of a hit page.

11. The method of claim 7, further comprising:
displaying a preselected number of archived web pages from the identified archived host site in equal number to said number of image display fields;
determining whether the identified archived host site has more pages than the preselected number of image display fields; and
streaming all pages of the identified archived host site through the image display fields if the identified archived web site has more pages than the preselected number of image display fields.

12. The method of claim 7, wherein a user station on the network includes a selection means for selecting an image display field of said series of image display fields, further comprising:
detecting the selection of an image display field displaying an archived page image;
locating on the computer network a page correlating to the archived page; and
retrieving the located page; and
displaying the located page.

13. The method of claim 7, wherein the search engine is in communication with a searchable advertisement archive of displayable advertisements having video and audio content, further comprising:
providing a first search engine web page including said search term input field and a predetermined plural number of video display fields;
redetermining the number of said video display fields;
if said redetermined number is less than said predetermined number, annexing juxtaposed video display fields to conform the resultant number of video display fields to said redetermined number;
selecting from said advertisement archive a plurality of advertisements in like number to said redetermined number of video display fields;
displaying the video content of said selected advertisements in said video display fields on said first web page;
if the redetermined number is greater than one, ordering said selected advertisements in a series; and
sequentially supplying audio content of the selected advertisements to the user station in the order of said series.
